(19) United States
(12) Patent Application Publication
(10) Pub. No.: US 2007/0019894 A1
(43) Pub. Date: Jan. 25, 2007

(54) Hydrodynamic bearing device

(75) Inventor: Takeyoshi Yamamoto, Ehime (JP)

Correspondence Address: BACON & THOMAS, PLLC, 625 SLATERS LANE, FOURTH FLOOR, ALEXANDRIA, VA, 22314, US

(73) Assignee: Matsushita Electric Industrial Co., Ltd., Osaka (JP)

(21) Appl. No.: 11/488,655

(22) Filed: Jul. 19, 2006

(30) Foreign Application Priority Data
Jul. 19, 2005 (JP) 2005-208095
Aug. 22, 2005 (JP) 2005-239355

(51) Int. Cl. F16C 32/06

(52) U.S. Cl. 384/107

(57) ABSTRACT

A hydrodynamic bearing device includes a rotary part including a shaft and a rotor hub; a stationary part including a bearing member, which has an inner peripheral surface radially confronting with an outer peripheral surface of the shaft, a bearing bore, and an upper surface axially confronting with a bottom surface of the rotor hub; a radial bearing portion formed between the outer peripheral surface of the shaft and the inner peripheral surface of the bearing member; a thrust bearing portion formed between the bottom surface of the rotor hub and the upper surface of the bearing member; and a communication hole having a first end opened radially outwardly at the thrust bearing portion and a second end opened toward a closed side of the first gap, the communication hole being formed at the bearing member.

### FIELD OF THE INVENTION

The present invention relates to a hydrodynamic bearing device, a motor using the hydrodynamic bearing device and an information device employing the motor.

### BACKGROUND OF THE INVENTION

As a bearing device for use in motors of hard disks, polygon mirrors for laser beam printers, optical disk devices or the like, a hydrodynamic bearing device is being extensively used in place of a conventionally available ball bearing device. As compared to the ball bearing device, the hydrodynamic bearing device is excellent in rotational precision and silentness. The demand for miniaturization and high rigidity of the motors grows stronger because their use has been expanded to portable equipments in recent years.

Japanese Patent Laid-open Publication No. 2004-19705 (“prior art reference 1”) discloses a small-sized and high rigidity bearing arrangement wherein, as shown in FIG. 9, sleeve 2 having radial dynamic pressure generating grooves 10 on its inner peripheral surface is encircled by holder 3 so that the outer peripheral surface of core spindle member 1 can cooperate with the inner peripheral surface of sleeve 2 to form a radial bearing.

Furthermore, holder 3 is provided with thrust dynamic pressure generating grooves 11 on its upper surface such that a thrust bearing is formed between the upper surface of holder 3 and the bottom surface of rotor hub 4. Lubricant that serves as working fluid is filled in those spatial parts including at least the radial bearing and the thrust bearing, namely, between the inner peripheral surface of sleeve 2 and the outer peripheral surface of core spindle member 1 and between the upper surface of holder 3 and the bottom surface of rotor hub 4.

With this arrangement, communication hole 12 for allowing the lubricant to flow therethrough is formed between the outer peripheral surface of sleeve 2 and the inner peripheral surface of holder 3. Communication hole 12 act to compensate the pressure differential which may occur in the lubricant retained at the axial top and bottom end portions between the inner peripheral surface of sleeve 2 and the outer peripheral surface of core spindle member 1 due to the cutting errors of the dynamic pressure generating grooves formed in the radial bearing portion or the cutting errors of the respective components or other factors. Such compensation of the pressure differential helps to suppress bubble generation and excessive rotor floating which would otherwise take place by the negative pressure in the lubricant.

Japanese Patent Laid-open Publication No. 2004-135419 (“prior art reference 2 ”) teaches an arrangement wherein, as illustrated in FIG. 10, encircling annulus member 15 having radial dynamic pressure generating grooves 10 on its outer peripheral surface is attached to the outer peripheral surface of core spindle member 1 so that the outer peripheral surface of encircling annulus member 15 can cooperate with the inner peripheral surface of holder 3 to form a radial bearing. Furthermore, holder 3 is provided with thrust dynamic pressure generating grooves 11 on its top surface such that a thrust bearing can be formed between the top surface of holder 3 and the underside of rotor hub 4.

Lubricant that serves as working fluid is filled in those parts including at least the radial bearing and the thrust bearing, namely, between the outer peripheral surface of encircling annulus member 15 and the inner peripheral surface of holder 3 and between the top surface of holder 3 and the underside of rotor hub 4.

With this arrangement, communication hole 12 for allowing the lubricant to flow therethrough is formed between the outer peripheral surface of core spindle member 1 and the inner peripheral surface of encircling annulus member 15. Communication hole 12 acts to compensate the pressure differential which may occur in the lubricant retained at the axial top and bottom end portions between the outer peripheral surface of encircling annulus member 15 and the inner peripheral surface of holder 3 due to the cutting errors of the dynamic pressure generating grooves formed in the radial bearing portion or the cutting errors of the respective components or other factors. Such compensation of the pressure differential helps to suppress bubble generation and excessive rotor floating which would otherwise take place by the negative pressure in the lubricant.

Japanese Patent Laid-open Publication No. 2004-239387 (“prior art reference 3”) proposes an arrangement wherein, as illustrated in FIG. 11, flanged sleeve 2 having radial dynamic pressure generating grooves 10 and thrust dynamic pressure generating grooves 11 on its inner peripheral surface and on the top surface of a flange portion, respectively, is encircled by holder 3.

A radial bearing is formed between the inner peripheral surface of flanged sleeve 2 and the outer peripheral surface of core spindle member 1, whereas a thrust bearing is formed between the top surface of the flange portion of flanged sleeve 2 and the underside of rotor hub 4. In this arrangement, communication hole 12 is provided between the outer peripheral surface of flanged sleeve 2 and the inner peripheral surface of holder 3, and between the underside of the flange portion of flanged sleeve 2 and the top surface of holder 3.

According to the conventional motor arrangements disclosed in prior art references 1 and 2, however, no communication hole is formed in the thrust bearing portion. Thus, no compensation is made for the pressure differential which may occur between the inner peripheral surface and the outer peripheral surface of the thrust bearing due to the cutting errors of thrust dynamic pressure generating grooves 11 and surrounding components or other factors. Such failure to compensate the pressure differential makes it impossible to suppress bubble generation and excessive rotor floating which would take place by the negative pressure in the lubricant.

In the case where the thrust bearing has spiral grooves as disclosed in prior art references 1 and 2, the pressure gradient in the thrust bearing portion is developed positively from the outer peripheral surface toward the inner peripheral surface. This means that negative pressure is hardly to build up within the thrust bearing, thus reducing the probability of bubble generation.

Even if bubbles were generated, they would be urged to move from a high pressure side to a low pressure side when the motor is in rotation. Thus, the bubble would be discharged to the outside prior to growing bigger, i.e., in a relatively small size. In contrast, in the case where the thrust bearing employs herringbone grooves, the pressure gradient in the thrust bearing portion becomes negative at the inner peripheral surface. Therefore, the bubbles cannot escape from the thrust bearing portion, as a result of which the bubbles tend to grow bigger and the rotor has a tendency to float up excessively.

Likewise, if the motor stops under the state that bubbles have been generated by increased dimensional errors or external disturbances such as a shock and the like and if the motor is exposed to a drastically reducing pressure, the bubbles are blocked off by the thrust bearing and cannot be discharged to the outside of the thrust bearing. This is because the sleeve makes close contact with the rotor in the thrust bearing portion during stoppage of the motor and hence the thrust dynamic pressure generating grooves having a depth of nothing more than 20 μm serve as the sole passage through which the lubricant and the bubbles should move.

In addition, due to the fact that the thrust dynamic pressure generating grooves are formed on the top surface of holder 3 whose area is quite small, difficulties may be encountered in forming a shoulder portion of desired profile on the top surface of holder 3 and in cutting the thrust dynamic pressure generating grooves with an enhanced degree of precision. For the same reason, the thrust dynamic pressure generating grooves cannot be formed in a cost-effective manner, e.g., through the use of a press-forming method and so forth, thus making it difficult to curtail the manufacturing costs.

On the other hand, according to the conventional motor arrangement taught in prior art reference 3, flanged sleeve 2 is used to form communication hole 12 between the outer peripheral surface of the thrust bearing and the bottom portion of the radial bearing. For this reason, even when a pressure differential occurs due to the cutting errors of the dynamic pressure generating grooves and the surrounding components or other factors, it is possible to suppress bubble generation and excessive rotor floating which would otherwise take place by the negative pressure in the lubricant. Use of flanged sleeve 2 also makes it easier to form the thrust dynamic pressure generating grooves. Therefore, the thrust dynamic pressure generating grooves can be formed by cost-effective methods such as a press-forming method and the like.

In the motor arrangement of prior art reference 3, however, communication hole 12 is horizontally opened at the underside of the flange portion of sleeve 2 close to the lubricant level surface of fluid seal portion 13. For this reason, if the motor stops under the state that bubbles have been generated in one of the radial bearing portion and the communication hole and if the atmosphere around a hard disk undergoes rapid pressure reduction, it is highly that the lubricant will be leaked out in the bubble discharging process. Moreover, use of flanged sleeve 2 having a thin flange portion may present difficulties in cutting the thrust dynamic pressure generating grooves and may reduce the cutting precision.

If the afore-mentioned motors are used in information devices such as a hard disk drive, a polygon mirror for laser beam printers, an optical disk device, a video tape recorder and the like, the leakage of lubricant is unavoidable, thus bitterly shortening the life span of the motors. Moreover, the lubricant thus leaked may either be smeared on a device head and a medium or adhere to the surface of the polygon mirror, in which event the task of recording and reproducing information cannot be performed in a proper manner. Depending on the circumstances, the lubricant leakage may lead to head crash, head scorching, scattering of a reflected laser beam and jitter or image dimming attendant on the laser beam scattering, which are fatal to the information devices or the medium.

### SUMMARY OF THE INVENTION

It is, therefore, an object of the present invention to provide a hydrodynamic bearing device, a motor and an information device that have an ability to compensate a pressure differential caused by cutting errors of dynamic pressure generating grooves and surrounding components or other factors, and further that make it easy to form the dynamic pressure generating grooves, while reliably preventing any leakage of lubricant, by properly arranging a bubble discharging communication hole.

The present invention provides a hydrodynamic bearing device. The hydrodynamic bearing device includes a rotary part having a shaft and a rotor hub; a stationary part having a bearing member, which is closed at one end and opened at another end, and contains an inner peripheral surface radially confronting with an outer peripheral surface of the shaft and an upper surface confronting with a bottom surface of the rotor hub in an axial direction; a radial bearing portion formed between the outer peripheral surface of the shaft and the inner peripheral surface of the bearing member, wherein fluid is filled in a first gap between the outer peripheral surface of the shaft and the inner peripheral surface of the bearing member and first dynamic pressure generating grooves are formed on at least one thereof; and a thrust bearing portion formed between the bottom surface of the rotor hub and the upper surface of the bearing member, wherein fluid is filled in a second gap between the bottom surface of the rotor hub and the upper surface of the bearing member and second dynamic pressure generating grooves are formed on at least one thereof, wherein a communication hole is provided at the bearing member, a first end of the communication hole opening radially outwardly at the thrust bearing portion and a second end thereof opening toward a closed side of the first gap, and wherein the rotary part rotates about the stationary part through the radial bearing portion and the thrust bearing portion.

The present invention also provides a spindle motor. The spindle motor includes the hydrodynamic bearing device described above: a rotor magnet being attached to the rotary part; and a stator core being affixed to the stationary part in confronting with the rotor magnet.

The present invention also provides a rotation device. The rotation device includes the spindle motor described above and a driven member being one of a polygon mirror and a recording disk and being attached to the rotary part.

### BRIEF DESCRIPTION OF THE DRAWINGS

The above and other objects and features of the present invention will become apparent from the following description of preferred embodiments, given in conjunction with the accompanying drawings, in which:

FIG. 1 is a cross sectional view of a motor in accordance with a first preferred embodiment of the present invention;

FIGS. 2A through 2D are enlarged cross sectional views showing thrust dynamic pressure generating grooves and radial dynamic pressure generating grooves employed in the first preferred embodiment;

FIGS. 3A through 3D are enlarged cross sectional views illustrating varying kinds of fluid seal portions “A” employed in the first preferred embodiment;

FIG. 4 is a cross sectional view depicting a modified example of a communication hole employed in the first preferred embodiment;

FIG. 5 is a cross sectional view of a motor in accordance with a second preferred embodiment of the present invention;

FIG. 6 is a cross sectional view of a motor in accordance with a third preferred embodiment of the present invention;

FIG. 7 is a cross sectional view schematically showing the internal configuration of a hard disk drive;

FIG. 8 is a cross sectional view of a spindle motor in accordance with a fourth preferred embodiment of the present invention;

FIG. 9 is a cross sectional view illustrating a prior art motor;

FIG. 10 is a cross sectional view illustrating another prior art motor; and

FIG. 11 is a cross sectional view illustrating still another prior art motor.

### DETAILED DESCRIPTION OF THE PREFERRED EMBODIMENTS

A hydrodynamic bearing device and a motor in accordance with the preferred embodiments of the present invention will now be described with reference to the accompanying drawings. The motor serves to rotate a record disk, e.g., a hard disk. As used hereinbelow, the term “upper”, “lower” or its equivalents refers to a direction that extends upward or downward as viewed in the drawings. However, it should be appreciated that the term is used merely for the convenience of description and is not intended to define a direction in a real mount condition.

### First Preferred Embodiment

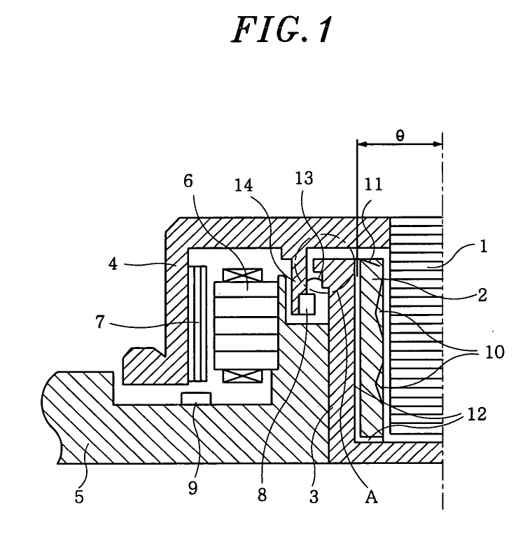

FIG. 1 is a half cross sectional view of a motor incorporating a hydrodynamic bearing device in accordance with a first preferred embodiment of the present invention. The motor includes core spindle member 1 of a cylindrical shape and rotor hub 4 having an annular lower surface portion (inner surface portion) and attached to an upper portion of core spindle member 1, both of which cooperate to form a rotor rotatable about an axis of core spindle member 1.

Sleeve 2 with a bearing bore is attached to an inner peripheral surface of holder 3, which remains closed at one end and opened at another end, by means of bonding, welding, press-fitting or other methods. Thus, sleeve 2 and holder 3 cooperate to form a bearing member. Sleeve 2 is disposed around an outer peripheral surface of core spindle member 1 with a small gap left therebetween. This allows the rotor, including core spindle member 1, to rotate with respect to sleeve 2. The bearing member including sleeve 2 and holder 3 is secured to base 5, thus forming a stator in cooperation with the latter.

Multiple magnet 7 of annular shape is attached to and extends along an inner peripheral surface of a lower portion of rotor hub 4. Stator core 6 is affixed to base 5 in a confronting relationship with magnet 7. If a controlled amount of electric current is caused to flow through a coil of stator core 6, a rotational force is generated between stator core 6 and magnet 7 to thereby rotate the rotor relative to the stator.

Lubricant that serves as working fluid is filled in between the outer peripheral surface of core spindle member 1 and the inner peripheral surface of sleeve 2. Radial dynamic pressure generating grooves 10 are formed on at least one of the outer peripheral surface of core spindle member 1 and the inner peripheral surface of sleeve 2. Rotation of core spindle member 1 creates a dynamic pressure between the outer peripheral surface of core spindle member 1 and the inner peripheral surface of sleeve 2, thus forming a radial bearing. By means of the radial bearing, core spindle member 1 is supported on sleeve 2 in a radially non-contacted condition.

Likewise, lubricant that serves as working fluid is filled in between the annular lower surface of rotor hub 4 and the top surface of sleeve 2. Thrust dynamic pressure generating grooves 11 are formed on at least one of the lower surface of rotor hub 4 and the top surface of sleeve 2. Rotation of rotor hub 4 creates a dynamic pressure between the lower surface of rotor hub 4 and the top surface of sleeve 2, thus forming a thrust bearing. By means of the thrust bearing, rotor hub 4 is supported on sleeve 2 in an axially non-contacted condition.

Attractor ring 9, made of a magnetic material, is attached to base 5 such that an attracting force is created between magnet 7 and attractor ring 9 to counterbalance the dynamic pressure developed in the thrust bearing, thereby allowing the rotor to be stably supported in an axial direction. Alternatively, such a magnetic biasing action may be induced by causing the axial magnetic center of magnet 7 to deviate from that of stator core 6.

A step portion extending radially outwardly with respect to core spindle member 1 is formed on the top outer peripheral portion of holder 3. Cylindrical wall portion 14 is formed on the underside of rotor hub 4 at a radial outer side of the thrust bearing such that it extends axially downwardly in a spaced-apart confronting relationship with the outer peripheral surface of holder 3.

Capillary fluid seal portion 13 for inhibiting any leakage of the lubricant is provided on and between the outer peripheral portion of holder 3 and the inner peripheral surface of cylindrical wall portion 14 of rotor hub 4. Removal inhibiting member 8 for keeping the rotor from removal out of the stator is attached to the inner peripheral surface of cylindrical wall portion 14 at below fluid seal portion 13.

Communication hole 12 is formed between sleeve 2 and holder 3 that constitute the bearing member, which communication hole 12 has an upper opening at a radial outer side of the thrust bearing and a lower opening at an axial lower side of the radial bearing. As can be seen in FIG. 1, the upper opening of communication hole 12 is oriented such that the angle θ made by the center line of the upper opening and the axis of core spindle member 1 becomes zero.

By forming such communication hole 12, a communication passage is created between the outer peripheral surface and the inner peripheral surface (including the radial bearing) of the thrust bearing, thus making it possible to compensate the pressure differential occurring in the thrust bearing. No thrust bearing exists between fluid seal portion 13 and the upper opening of communication hole 12. This ensures that the bubbles are discharged to the outside of the bearings immediately upon generation without being blocked off by an otherwise formed thrust bearing. Further, communication hole 12 is not opened in close proximity to the level surface of fluid seal portion 13. This eliminates the possibility that the lubricant is leaked out together with the bubbles.

Communication hole 12 can be readily formed between the outer peripheral surface of sleeve 2 and the inner peripheral surface of holder 3 by forming an axially extending groove on at least one of the outer peripheral surface of sleeve 2 and the inner peripheral surface of holder 3. The groove may have any arbitrary shape as long as it extends in an axial direction. For instance, a spiral groove (not shown) may be formed on the outer peripheral surface of sleeve 2.

In the case where communication hole 12 is formed on the inner peripheral surface of holder 3, costs can be saved by forming it through the use of a casting method, a forging method, a resin-molding method or the like. In order to form communication hole 12 on the lower surface of sleeve 2, use is made of, e.g., a method by which sleeve 2 is attached to holder 3 while leaving a gap between the closed-end bottom surface of holder 3 and the lower surface of sleeve 2 or a method by which a radial groove is formed on at least one of the lower surface of sleeve 2 and the closed-end bottom surface of holder 3.

Although the bearing member of the first preferred embodiment is of a two-part structure including sleeve 2 and holder 3, it may be configured of a single component, in which case communication hole 12 can be formed by machining, laser cutting, electrolysis or the like. Furthermore, the bearing member may be divided into three or more parts, in which case it becomes possible to form the openings of communication hole 12 somewhere along the radial bearing or between the thrust bearing and the radial bearing.

If sleeve 2 is made of a porous body or a resin material, it becomes possible to form thrust dynamic pressure generating grooves 11 and radial dynamic pressure generating grooves 10 by a cost-effective method such as press-forming or the like, thus achieving reduction in the manufacturing costs. Thanks to the fact that, unlike in the prior art, thrust dynamic pressure generating grooves 11 are not formed on holder 3 but on sleeve 2, it is possible to simultaneously form thrust dynamic pressure generating grooves 11 and radial dynamic pressure generating grooves 10, which further reduces the manufacturing costs.

Core spindle member 1 is typically made of stainless steel. There are many kinds of porous bodies or resin materials whose linear expansion coefficient is greater than that of stainless steel. Thus, in the event that sleeve 2 is made of a porous body or a resin material, the bearing gap is changed in response to the temperature variation, which leads to increased fluctuation in the bearing rigidity and the bearing torque loss. The thermal expansion of sleeve 2 and hence the variation in the bearing gap can be suppressed by making the linear expansion coefficient of holder 3 smaller than that of sleeve 2. This effect can be further enhanced by substantially equalizing the linear expansion coefficients of core spindle member 1 and holder 3, in which case sleeve 2 may be made of a metallic material in place of the porous body or the resin material.

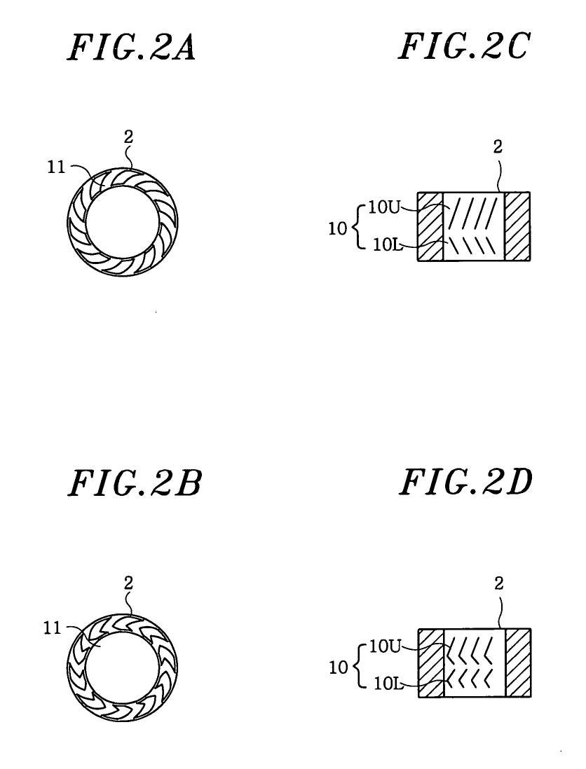

FIGS. 2A through 2D illustrate shapes of thrust dynamic pressure generating grooves 11 and radial dynamic pressure generating grooves 10. FIGS. 2A and 2B are top views of sleeve 2, and FIGS. 2C and 2D are cross sectional views thereof.

Thrust dynamic pressure generating grooves 11 are of a pump-in shape capable of, when the rotor is in rotation, inducing a pressure gradient by which the lubricant is urged to flow radially inwardly. Examples of thrust dynamic pressure generating grooves 11 include spiral grooves as illustrated in FIG. 2A and herringbone grooves of an unbalanced shape each having an inner groove part and an outer groove part longer than the inner groove part, as depicted in FIG. 2B.

Examples of radial dynamic pressure generating grooves 10 include generally unbalanced apex removed chevron-shaped grooves each having axial upper groove part 10U and axial lower groove part 10L shorter than axial upper groove part 10U, as illustrated in FIG. 2C, and a pair of upper and lower herringbone grooves 10U and 10L, as depicted in FIG. 2D. Radial dynamic pressure generating grooves 10 are also of a pump-in shape capable of, when the rotor is in rotation, inducing a pressure gradient by which the lubricant is urged to flow axially downwardly.

This configuration allows the lubricant to flow through the thrust bearing, the radial bearing and communication hole 12 in the named sequence. Thus, once bubbles are generated somewhere in the bearings, they can be rapidly discharged to the outside through communication hole 12. Such flow of lubricant is induced as far as one of thrust dynamic pressure generating grooves 11 and radial dynamic pressure generating grooves 10 has the pump-in shape, although it is preferred that both should be formed in the pump-in shape as noted above.

Furthermore, although two rows of herringbone grooves are illustrated in FIG. 2D, the herringbone grooves may be formed in one row or more than three rows. Moreover, unlike the example illustrated in FIG. 2D wherein the herringbone grooves in the upper row are of an unbalanced shape and the herringbone grooves in the lower row are generally symmetrical, it is a matter of course that the unbalanced shape may be adopted by the herringbone grooves in the lower row or the herringbone grooves in both rows.

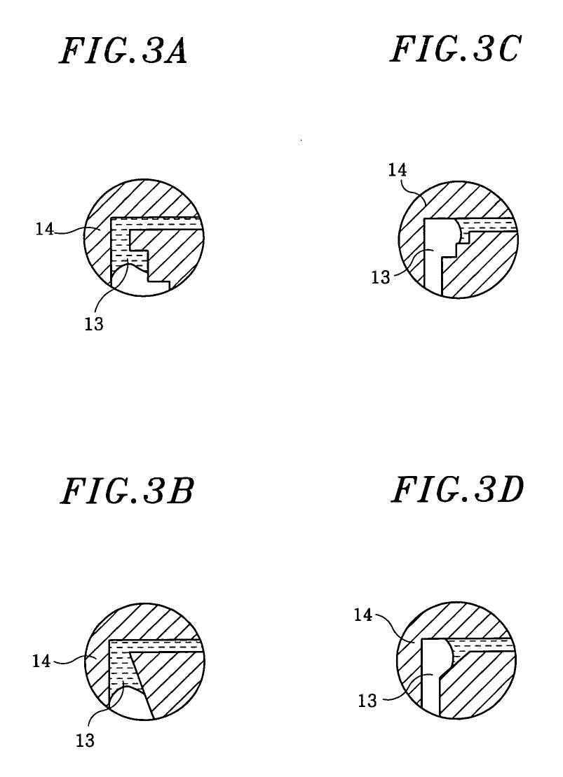

FIGS. 3A through 3D are enlarged cross sectional views illustrating various examples of fluid seal portion 13 provided at the radial outer side of communication hole 12 and designated by reference character “A” in FIG. 1. Examples of fluid seal portion 13 of the type formed between the outer peripheral surface of holder 3 and the inner peripheral surface of cylindrical wall portion 14 include a transversely stepped fluid seal as illustrated in FIG. 3A and a transversely tapering fluid seal as illustrated in FIG. 3B. Further, examples of fluid seal portion 13 of the type formed between the top surface of holder 3 and the underside of rotor hub 4 include a longitudinally stepped fluid seal as depicted in FIG. 3C and a longitudinally tapering fluid seal as depicted in FIG. 3D.

These fluid seals are gradually widened as they come closer to the opening side thereof and take advantage of a capillary force in providing their sealing effects. Although these fluid seals may be employed as a unit, combined use of them would help to improve the sealing ability.

For example, if the longitudinally stepped fluid seal (FIG. 3C) and the transversely stepped fluid seal (FIG. 3A) are employed in combination, the transversely stepped fluid seal (FIG. 3A) can retain the lubricant against leakage even when the lubricant has moved past the longitudinally stepped fluid seal (FIG. 3C) by a great amplitude of shock. This also enables the transversely stepped fluid seal (FIG. 3A) to retain an increased quantity of lubricant. Although each of the transversely stepped fluid seal (FIG. 3A) and the longitudinally stepped fluid seal (FIG. 3C) is designed to have two steps in the illustrated examples, it should be understood that no restriction is imposed on the number of steps in the first preferred embodiment.

Next, the internal configuration of a typical hard disk drive used in computers and so forth will be set forth with reference to FIG. 7.

Hard disk drive 20 includes rectangular housing 21 whose internal space is kept clean in a condition substantially free from debris, dusts or the like. Disposed inside housing 21 is spindle motor 22 to which disks 23 of a circular shape are mounted for rotation therewith.

Further accommodated within housing 21 is head moving mechanism 25 that includes head 27 for reading and writing information from and on disk 23, arm 26 for holding head 27, and actuator portion 24 for displacing head 27 and arm 26 to a target position on disk 23.

The motor incorporating the hydrodynamic bearing device in accordance with the first preferred embodiment enjoys a drastic curtailment in the risk of lubricant leakage and therefore can reduce the possibility of performance degradation even in the case of a disturbance being caused by shock or at the time of environment change. Further, the possibility is eliminated that the lubricant is splashed into between the head and the medium to thereby cause a so-called head crash. This allows the hard disk drive to be used in a greatly broadened spectrum of applications, unlike the prior art motors that have been subjected to severe restriction in their environment of use.

It goes without saying that the hydrodynamic bearing device and the motor in accordance with the first preferred embodiment can find their applications in a variety of information devices such as a polygon mirror driving spindle motor for laser beam printers, a spindle motor for optical disk drives inclusive of compact disk drives, a rotary head drum motor for video tape recorders and the like.

While a hydrodynamic bearing device, a motor and an information device have been described in the foregoing in conjugation with the first preferred embodiment, it should be understood that the present invention is not limited to the first preferred embodiment and many changes and modifications may be made without departing from the scope of invention defined in the claims.

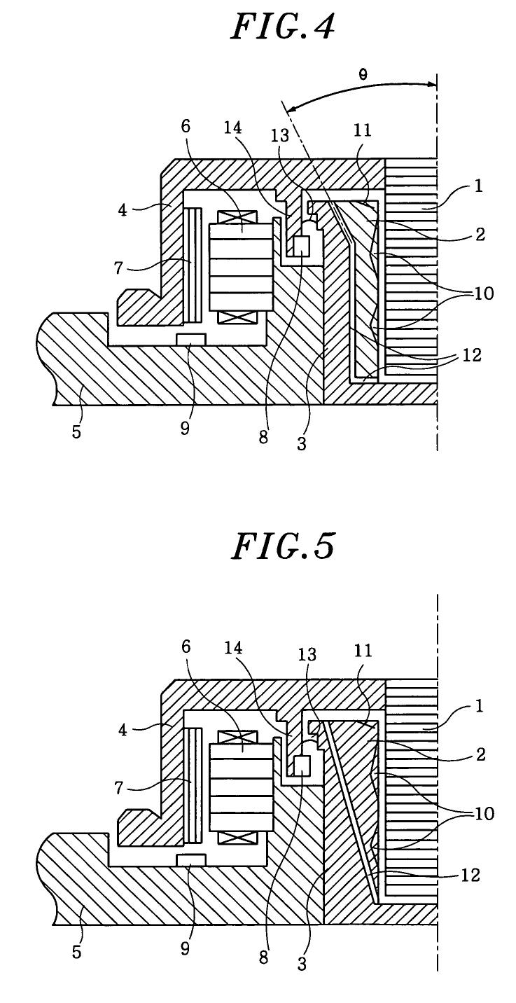

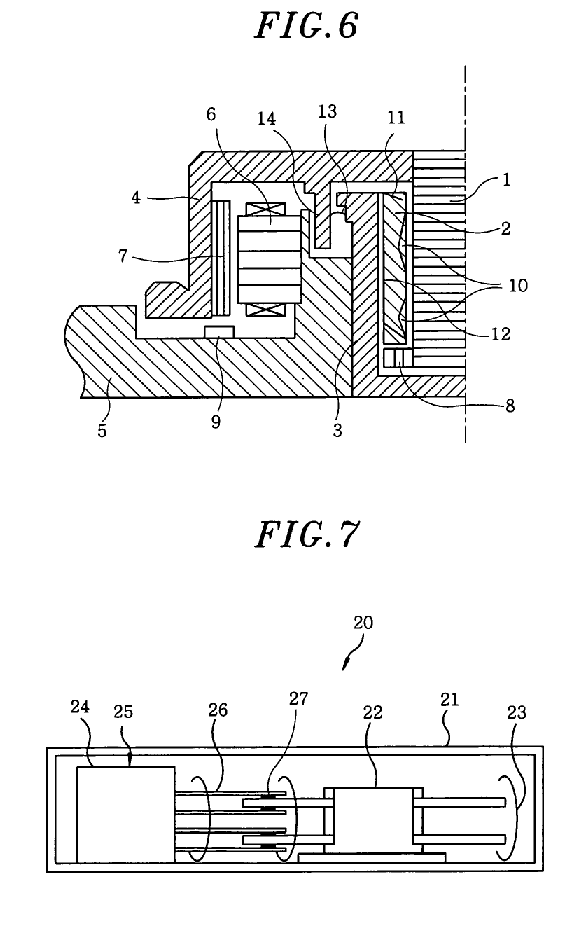

Taking an example, the angle θ of communication hole 12 with respect to the axis of core spindle member 1 may be arbitrarily changed, although the angle θ is equal to zero in the first preferred embodiment. More specifically, as shown in FIG. 4, communication hole 12 may be slanted radially outwardly at its upper extension such that the upper opening of communication hole 12 lies at the top outermost peripheral area of holder 3. This allows the grooves in the thrust bearing to be formed farther away from core spindle member 1. The same bubble discharge effect as set forth above can be attained by the modified example because the lower end of the radial bearing is kept in communication with the outer periphery of the thrust bearing through communication hole 12.

### Second Preferred Embodiment

FIG. 5 is a cross sectional view of a motor in accordance with a second preferred embodiment of the present invention. Contrary to the first preferred embodiment wherein the stator-side bearing member includes two parts, i.e., sleeve 2 and holder 3, the motor of the second preferred embodiment is provided with single piece bearing member 31 that has the functions of both sleeve 2 and holder 3 employed in the first preferred embodiment.

Bearing member 31, which is closed at one end and opened at another end, includes radial dynamic pressure generating grooves 10 on its inner peripheral surface, thrust dynamic pressure generating grooves 11 on its top surface and communication hole 12 extending between the outer end side of thrust dynamic pressure generating grooves 11 and the closed (lower) end side of radial dynamic pressure generating grooves 10. Except for these points, the motor of the second preferred embodiment is the same in configuration as the motor of the first preferred embodiment described above.

This configuration helps not only to reduce the number of parts and the number of machined surfaces but also to eliminate the fixing process (bonding, welding, press-fitting or the like) which would otherwise be needed to couple a sleeve and a holder together, thereby achieving curtailment of manufacturing costs.

### Third Preferred Embodiment

FIG. 6 is a cross sectional view of a motor in accordance with a third preferred embodiment of the present invention. Contrary to the first preferred embodiment wherein removal inhibiting member 8 is attached to cylindrical wall portion 14, the motor in accordance with the third preferred embodiment is provided with removal inhibiting member 8 on the lower side of core spindle member 1. This configuration makes it easy to form removal inhibiting member 8. Furthermore, it becomes possible to form hydrodynamic bearings between the lower surface of removal inhibiting member 8 and the bottom surface of holder 3 and further between the upper surface of removal inhibiting member 8 and the lower surface of sleeve 2, thereby improving the rigidity of the thrust bearing.

### Fourth Preferred Embodiment

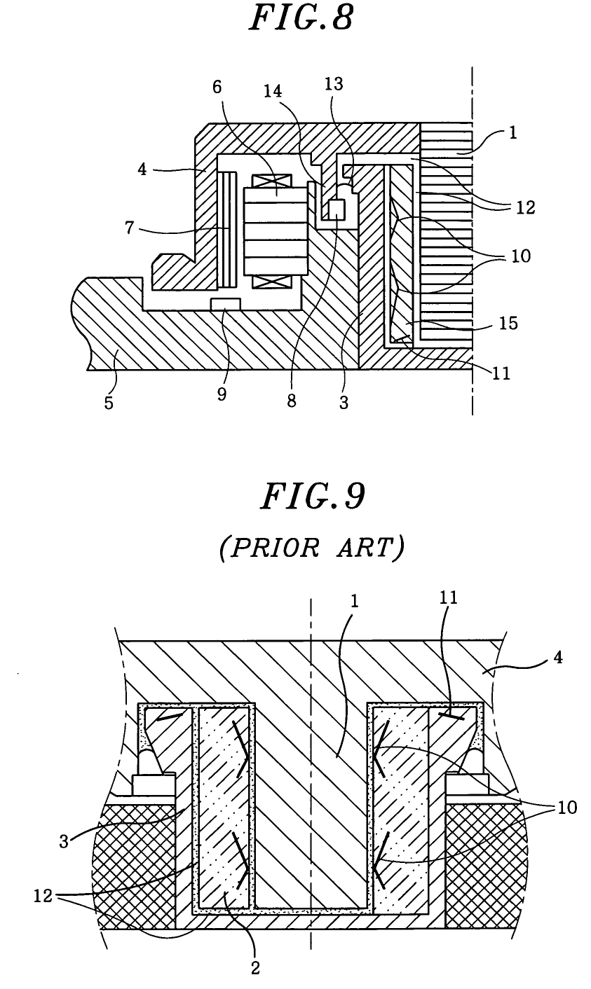

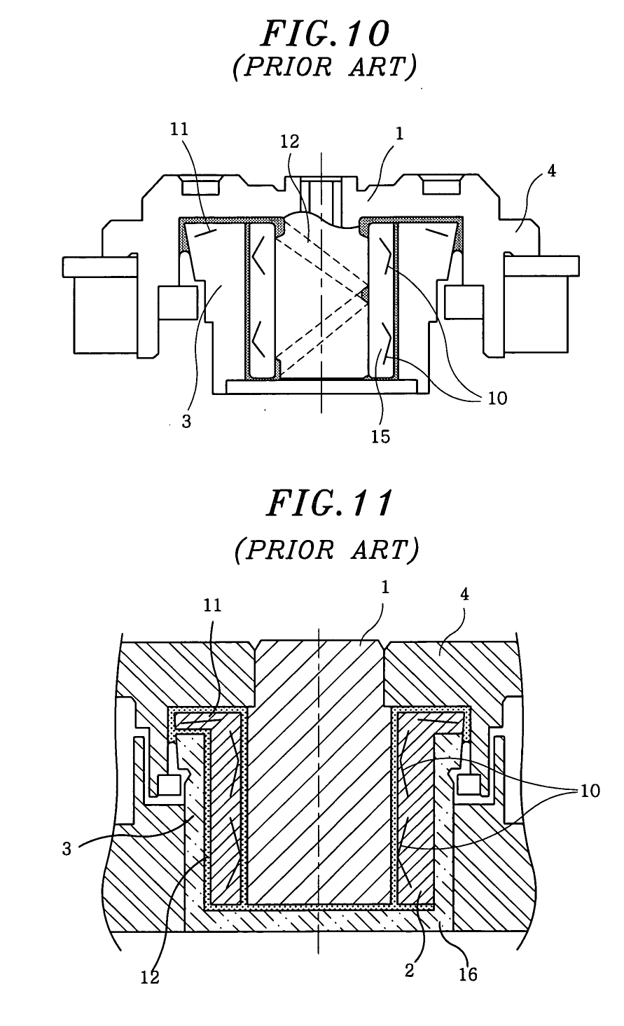

FIG. 8 is a cross sectional view of a spindle motor in accordance with a fourth preferred embodiment of the present invention. The spindle motor includes core spindle member 1 and rotor hub 4 attached to core spindle member 1, both of which cooperate to form a rotor rotatable about an axis of core spindle member 1. Encircling annulus member 15 is attached to core spindle member 1, thus constituting a shaft member. Holder 3, which is closed at one end and opened at another end, constitutes a bearing member. Holder 3 is disposed around the outer peripheral surface of encircling annulus member 15 with a small gap left therebetween. This allows the rotor, which includes core spindle member 1 and encircling annulus member 15, to rotate with respect to holder 3. Moreover, holder 3 is secured to base 5, thus forming a stator in cooperation with the latter.

Multiple magnet 7 of an annular shape is attached to and extends along the inner peripheral surface of rotor hub 4. Stator core 6 is affixed to base 5 in a confronting relationship with magnet 7. If a controlled amount of electric current is caused to flow through a coil of stator core 6, a rotational force is generated between stator core 6 and magnet 7 to thereby rotate the rotor relative to the stator.

Lubricant that serves as working fluid is filled in between the outer peripheral surface of encircling annulus member 15 and the inner peripheral surface of holder 3. Radial dynamic pressure generating grooves 10 are formed on at least one of the outer peripheral surface of encircling annulus member 15 and the inner peripheral surface of holder 3. Rotation of encircling annulus member 15 creates a dynamic pressure between the outer peripheral surface of encircling annulus member 15 and the inner peripheral surface of holder 3, thus forming a radial dynamic pressure bearing. By means of the radial dynamic pressure bearing, encircling annulus member 15 is supported on holder 3 in a radially non-contacted condition.

Lubricant that serves as working fluid is also filled in between the lower surface of encircling annulus member 15 and the bottom surface of holder 3. Thrust dynamic pressure generating grooves 11 are formed on at least one of the lower surface of encircling annulus member 15 and the bottom surface of holder 3. Rotation of encircling annulus member 15 creates a dynamic pressure between the lower surface of encircling annulus member 15 and the bottom surface of holder 3, thus forming a thrust dynamic pressure bearing. By means of the thrust dynamic pressure bearing, encircling annulus member 15 is supported on holder 3 in an axially non-contacted condition.

Attractor ring 9, made of a magnetic material, is attached to base 5 such that an axial attracting force is created between magnet 7 and attractor ring 9 to counterbalance the dynamic pressure of the thrust dynamic pressure bearing, thereby allowing the rotor to be stably supported in an axial direction. Alternatively, such a magnetic biasing action may be induced by causing the axial magnetic center of magnet 7 to deviate from that of stator core 6.

A step portion extending radially outwardly with respect to core spindle member 1 is formed on the top outer peripheral portion of holder 3. Cylindrical wall portion 14 is formed on the underside of rotor hub 4 at a radial outer side of the thrust bearing such that it extends axially downwardly in a spaced-apart confronting relationship with the outer peripheral surface of holder 3. Fluid seal portion 13 for inhibiting leakage of the lubricant is provided between the outer peripheral portion of holder 3 and the inner peripheral surface of cylindrical wall portion 14, which fluid seal portion 13 takes advantage of a capillary force. Removal inhibiting member 8 for keeping the rotor from removal out of the stator is attached to the inner peripheral surface of cylindrical wall portion 14 at below fluid seal portion 13.

Communication hole 12 is formed between core spindle member 1 and encircling annulus member 15, both of which constitute a shaft member. Communication hole 12 has a lower opening at a radial inner side of the thrust bearing and an upper opening at an axial upper side of the radial bearing.

By forming such communication hole 12, the top end and the bottom end (including the thrust bearing) of the radial bearing are kept in communication with each other, thus making it possible to compensate the pressure differential occurring in the radial bearing. It also possible to compensate the pressure differential occurring in the thrust bearing, because the outer peripheral surface side (including the radial bearing) and the inner peripheral side of the thrust bearing are kept in communication with each other. Neither thrust bearing nor radial bearing exists between the top end of the radial bearing and the upper opening of communication hole 12. This ensures that the bubbles are discharged to the outside of the bearings without being blocked off by an otherwise formed thrust bearing. Further, communication hole 12 is not opened in close proximity to the level surface of fluid seal portion 13. This eliminates the possibility that the lubricant is leaked out together with the bubbles.

Communication hole 12 can be readily formed between the outer peripheral surface of core spindle member 1 and the inner peripheral surface of encircling annulus member 15 by forming an axially extending groove on at least one of the outer peripheral surface of core spindle member 1 and the inner peripheral surface of encircling annulus member 15. In order to form communication hole 12 on the upper side of encircling annulus member 15, use is made of, e.g., a method by which encircling annulus member 15 is attached to core spindle member 1 while leaving a gap between the underside of rotor hub 4 and the upper surface of encircling annulus member 15 or a method by which a radial groove is formed on at least one of the underside of rotor hub 4 and the upper surface of encircling annulus member 15.

Although the shaft member of the fourth preferred embodiment is of a two-part structure including core spindle member 1 and encircling annulus member 15, it may be configured of a single component, in which case communication hole 12 can be formed by machining, laser cutting, electrolysis or the like. Furthermore, the shaft member may be configured of three or more parts, in which case it becomes possible to form the openings of communication hole 12 somewhere along the radial bearing or between the thrust bearing and the radial bearing.

If encircling annulus member 15 is made of a porous body or a resin material, it becomes possible to form thrust dynamic pressure generating grooves 11 and radial dynamic pressure generating grooves 10 by a cost-effective method such as press-forming or the like, thus achieving reduction in the manufacturing costs. Thanks to the fact that, unlike in the prior art, thrust dynamic pressure generating grooves 11 are not formed on holder 3 but on encircling annulus member 15, it is possible to form thrust dynamic pressure generating grooves 11 and radial dynamic pressure generating grooves 10 at one time, which further reduces the manufacturing costs.

Although the motors of the preferred embodiments are of an inner rotor type, it is needless to say that they may adapt themselves to an inner rotor type.

The hydrodynamic bearing device and the motor employing the same in accordance with the preferred embodiments can be used as a rotation device for hard disk drives, laser beam printers, optical disk devices and so forth.

With the preferred embodiments of the invention noted above, the communication hole is opened at the radial outer side of the thrust bearing portion. This makes it possible to compensate the pressure differential in the thrust bearing portion regardless of the shape of the thrust dynamic pressure generating grooves. Further, the bubbles are not blocked off by the thrust bearing and therefore can be discharged to the outside of the bearing. Moreover, the communication hole is not opened toward the fluid seal portion lying at an outermost peripheral position but opened upwardly, thus precluding the possibility that the lubricant is leaked out together with the bubbles in the bubble discharging process.

In addition, even if the motor incorporating the hydrodynamic bearing device in accordance with the preferred embodiments is fabricated with a varying degree of precision and even if the motor and the rotation device employing the same are maintained and operated in a reducing pressure atmosphere or under a vibratory-shock-applying environment, the lubricant is kept free from any leakage. It is also possible to reduce the manufacturing costs to a great extent and to prolong the life span of the motor, as compared to the prior art.

What is claimed is:

1. A hydrodynamic bearing device comprising:
a rotary part including a shaft and a rotor hub;
a stationary part including a bearing member, which is closed at one end and opened at another end, and has an inner peripheral surface radially confronting with an outer peripheral surface of the shaft and an upper surface confronting with a bottom surface of the rotor hub in an axial direction;
a radial bearing portion formed between the outer peripheral surface of the shaft and the inner peripheral surface of the bearing member, wherein fluid is filled in a first gap between the outer peripheral surface of the shaft and the inner peripheral surface of the bearing member and first dynamic pressure generating grooves are formed on at least one thereof; and
a thrust bearing portion formed between the bottom surface of the rotor hub and the upper surface of the bearing member, wherein fluid is filled in a second gap between the bottom surface of the rotor hub and the upper surface of the bearing member and second dynamic pressure generating grooves are formed on at least one thereof,
wherein a communication hole is provided at the bearing member, a first end of the communication hole opening radially outwardly at the thrust bearing portion and a second end thereof opening toward a closed side of the first gap,
and wherein the rotary part rotates about the stationary part through the radial bearing portion and the thrust bearing portion.

2. The hydrodynamic bearing device of claim 1, wherein the bearing member is configured of a sleeve having the inner peripheral surface of the bearing member and a holder for retaining the sleeve on an inner peripheral surface of the holder, the holder being closed at one end and opened at another end, wherein the thrust bearing portion is formed between the bottom surface of the rotor hub and an upper surface of the sleeve, and wherein the communication hole is formed between mutually confronting surfaces of the sleeve and the holder.

3. The hydrodynamic bearing device of claim 2, wherein the communication hole is defined by the inner peripheral surface of the holder and a groove continuously formed across opposite ends of an outer peripheral surface of the sleeve.

4. The hydrodynamic bearing device of claim 2, wherein the communication hole is defined by an outer peripheral surface of the sleeve and a groove continuously formed across opposite ends of the inner peripheral surface of the holder.

5. The hydrodynamic bearing device of claim 2, wherein the sleeve is made of one of a porous body and a resin material.

6. The hydrodynamic bearing device of claim 2, wherein the holder has a linear expansion coefficient smaller than that of the sleeve.

7. The hydrodynamic bearing device of claim 1, wherein the first dynamic pressure generating grooves are of a pump-in shape capable of making the fluid urged to flow radially inwardly, and wherein the second dynamic pressure generating grooves are of a pump-in shape capable of making the fluid urged to flow axially from said another end toward said one end of the bearing member in the axial direction.

8. The hydrodynamic bearing device of claim 7, wherein the second dynamic pressure generating grooves of the thrust bearing portion are one of spiral grooves and herringbone grooves of an unbalanced shape.

9. The hydrodynamic bearing device of claim 7, wherein the first dynamic pressure generating grooves of the radial bearing portion are generally unbalanced apex removed chevron-shaped grooves or herringbone grooves of an unbalanced shape.

10. The hydrodynamic bearing device of claim 1, wherein a cylindrical wall portion is formed on the bottom surface of the rotor hub in a radially spaced-apart relationship with an outer peripheral surface of the bearing member, and wherein a capillary fluid seal portion is provided on an inner peripheral surface of the cylindrical wall portion and the outer peripheral surface of the bearing member.

11. The hydrodynamic bearing device of claim 10, wherein the fluid seal portion includes at least one step portion formed on one of the inner peripheral surface of the cylindrical wall portion and the outer peripheral surface of the bearing member, the step portion being of such a shape that a gap between the inner peripheral surface of the cylindrical wall portion and the outer peripheral surface of the bearing member is increased as the step portion extends farther away from the bottom surface of the rotor hub.

12. The hydrodynamic bearing device of claim 10, wherein the fluid seal portion includes at least one tapering portion formed on one of the inner peripheral surface of the cylindrical wall portion and the outer peripheral surface of the bearing member, the tapering portion being of such a shape that a gap between the inner peripheral surface of the cylindrical wall portion and the outer peripheral surface of the bearing member is gradually increased as the tapering portion extends farther away from the bottom surface of the rotor hub.

13. The hydrodynamic bearing device of claim 10, wherein another capillary fluid seal portion is provided on the bottom surface of the rotor hub lying at a radial outer side of the radial bearing portion and the upper surface of the bearing member lying at an radial outer side of the communication hole.

14. The hydrodynamic bearing device of claim 13, wherein said another fluid seal portion includes at least one step portion formed on one of the upper surface of the bearing member and the bottom surface of the rotor hub, the step portion of said another fluid seal portion being of such a shape that a gap between the upper surface of the bearing member and the bottom surface of the rotor hub is increased as the step portion extends farther away from the communication hole.

15. The hydrodynamic bearing device of claim 13, wherein said another fluid seal portion includes at least one tapering portion formed on one of the upper surface of the bearing member and the bottom surface of the rotor hub, the tapering portion of said another fluid seal portion being of such a shape that a gap between the upper surface of the bearing member and the bottom surface of the rotor hub is gradually increased as the tapering portion extends farther away from the communication hole.

16. A spindle motor comprising:
a hydrodynamic bearing device including:
a rotary part having a shaft and a rotor tub;
a stationary part having a bearing member, which is closed at one end and opened at another end, and contains an inner peripheral surface radially confronting with an outer peripheral surface of the shaft and an upper surface confronting with a bottom surface of the rotor hub in an axial direction;
a radial bearing portion formed between the outer peripheral surface of the shaft and the inner peripheral surface of the bearing member, wherein fluid is filled in a first gap between the outer peripheral surface of the shaft and the inner peripheral surface of the bearing member and first dynamic pressure generating grooves are formed on at least one thereof; and
a thrust bearing portion formed between the bottom surface of the rotor hub and the upper surface of the bearing member, wherein fluid is filled in a second gap between the bottom surface of the rotor hub and the upper surface of the bearing member and second dynamic pressure generating grooves are formed on at least one thereof,
wherein a communication hole is provided at the bearing member, a first end of the communication hole opening radially outwardly at the thrust bearing portion and a second end thereof opening toward a closed side of the first gap,
and wherein the rotary part rotates about the stationary part through the radial bearing portion and the thrust bearing portion;
a rotor magnet being attached to the rotary part; and
a stator core being affixed to the stationary part in confronting with the rotor magnet.

17. A rotation device comprising:
a spindle motor including:
a hydrodynamic bearing device having:
a rotary part containing a shaft and a rotor hub;
a stationary part containing a bearing member, which is closed at one end and opened at another end, and contains an inner peripheral surface radially confronting with an outer peripheral surface of the shaft and an upper surface confronting with a bottom surface of the rotor hub in an axial direction;
a radial bearing portion formed between the outer peripheral surface of the shaft and the inner peripheral surface of the bearing member, wherein fluid is filled in a first gap between the outer peripheral surface of the shaft and the inner peripheral surface of the bearing member and first dynamic pressure generating grooves are formed on at least one thereof; and
a thrust bearing portion formed between the bottom surface of the rotor hub and the upper surface of the bearing member, wherein fluid is filled in a second gap between the bottom surface of the rotor hub and the upper surface of the bearing member and second dynamic pressure generating grooves are formed on at least one thereof,
wherein a communication hole is provided at the bearing member, a first end of the communication hole opening radially outwardly at the thrust bearing portion and a second end thereof opening toward a closed side of the first gap,
and wherein the rotary part rotates about the stationary part through the radial bearing portion and the thrust bearing portion;
a rotor magnet being attached to the rotary part;
a stator core being affixed to the stationary part in confronting with the rotor magnet; and
a driven member being one of a polygon mirror and a recoding disk and being attached to the rotary part.
